(19) United States
(12) Patent Application Publication
(10) Pub. No.: US 2020/0313361 A1
(43) Pub. Date: Oct. 1, 2020

(54) CONNECTOR

(71) Applicant: Sumitomo Wiring Systems, Ltd., Yokkaichi-shi (JP)

(72) Inventors: Yuki Kondo, Yokkaichi-shi (JP); Long Chen, Yokkaichi-shi (JP)

(21) Appl. No.: 16/832,058

(22) Filed: Mar. 27, 2020

(30) Foreign Application Priority Data
Mar. 28, 2019 (JP) 2019-063142

(51) Int. Cl. H01R 13/6585; H01R 13/46

(52) U.S. Cl. CPC H01R 13/6585; H01R 13/46

(57) ABSTRACT

A connector (10) includes a first terminal group (36), a second terminal group (38), an insulating housing (30) and a conductive member (60). The first terminal group (36) includes terminals (20) arranged side by side, and the second terminal group (38) also includes terminals (20) arranged side by side. The housing (30) holds the first terminal group (36) and the second terminal group (38) arranged in two stages. The conductive member (60) includes a partition (62) and two extending portions (64). The partition (62) is a plate and held in the housing (30) to partition between the first terminal group (36) and the second terminal group (38). The extending portions (64) extend toward either the first terminal group or the second terminal group (38) from both side edges of the partitioning portion (62).

### BACKGROUND

### Field of the Invention

This disclosure relates to a connector.

### Related Art

Japanese Unexamined Patent Publication No. 2018-113197 discloses a board connector for high-speed transmission of an electrical signal. This connector is provided with first and second terminal groups, a housing for holding the terminal groups and a flat conductive plate. The first and second terminal groups are arranged respectively in upper and lower stages in the housing. The plate is held in the housing to vertically partition the first and second terminal groups to reduce or avoid electrical adverse effects, such as crosstalk occurring between the terminal groups.

The plate in the above connector can vertically partition the first and second terminal groups. However, if an interval between the terminal groups is narrow, signals and noise of each terminal group easily are transmitted to the other terminal group from both sides of the plate. Thus, even if the plate is arranged between the first and second terminal groups, there is still a concern about electrical adverse effects, such as crosstalk occurring between the terminal groups.

A connector for suppressing electrical adverse effects between terminal groups is disclosed in this specification.

### SUMMARY

This disclosure is directed to a connector with a first terminal group, a second terminal group, an insulating housing and a conductive member. Each terminal group includes terminals arranged side by side. The housing holds the first terminal group and the second terminal group in two stages. The conductive member includes a partition and two extending portions. The partition is a plate that is held in the housing to partition between the first and second terminal groups. The extending portions extend toward either the first terminal group or the second terminal group from both sides of the partition.

The extending portions suppress transmission of signals and noise of each terminal group toward the other terminal group from the side edges of the partition. Thus, crosstalk between the first and second terminal groups can be suppressed, and electrical adverse effects on high-frequency characteristics can be reduced or avoided.

The extending portions may extend to positions for covering side parts of either the first terminal group or the second terminal group. That is, a large creepage distance between the first and second terminal groups can be secured. In this way, the extending portions of the partition can reliably suppress the transmission of signals and noise of each terminal group to the other terminal group from the side edges of the partition.

The housing may cover the extending portions. Thus, the extending portions can be prevented from being broken, such as by contacting a mating connector when the connector is connected to the mating connector.

Accordingly, electrical adverse effects between terminal groups are suppressed.

A specific example of the connector of this disclosure is described below with reference to the drawings. The invention is not limited to these illustrations, but is defined by the claims and includes all changes in the scope of claims and in the meaning and scope of equivalents.

### BRIEF DESCRIPTION OF DRAWINGS

FIG. 1 is a front view of a connector.

FIG. 2 is a perspective view of the connector with a shield shell removed.

FIG. 3 is a section along of FIG. 1.

FIG. 4 is a section corresponding to a cross-section along IV-IV of FIG. 3.

### DETAILED DESCRIPTION

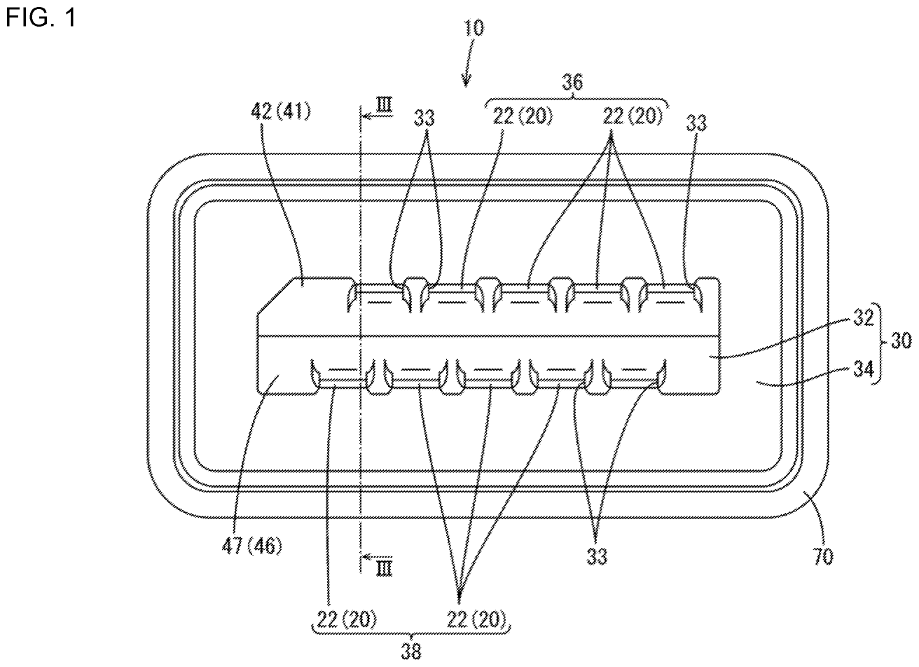

An embodiment is described with reference to FIGS. 1 to 4.

[Connector 10]

A connector 10 according to this embodiment is a shield connector to be mounted on ends of wires W. As shown in FIGS. 1 to 3, the connector 10 includes terminals 20, a housing 30, a conductive member 60 and a shield shell 70. In the following description, some identical members may be denoted by a reference sign but others may not.

[Terminals 20]

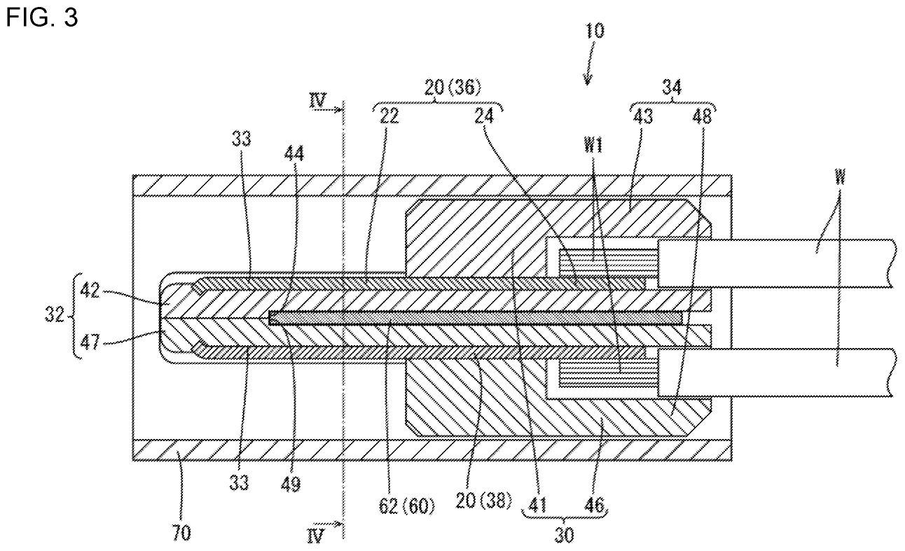

Each terminal 20 is formed by working a conductive metal plate. As shown in FIG. 3, the terminal 20 includes a terminal connecting portion 22 and a wire connecting portion 24. The terminal connecting portion 22 is a flat plate long in a front-rear direction. The terminal connecting portion 22 is connectable to a mating terminal of an unillustrated mating connector.

The wire connecting portion 24 is behind the terminal connecting portion 22. The wire connecting portion 24 is connected to a core W1 exposed at the end of the wire W. In this way, the terminal 20 is connected electrically to the end of the wire W.

[Housing 30]

The housing 30 is made of insulating synthetic resin. As shown in FIGS. 1 to 4, the housing 30 includes a fitting 32 and a terminal holding portion 34.

[Fitting 32]

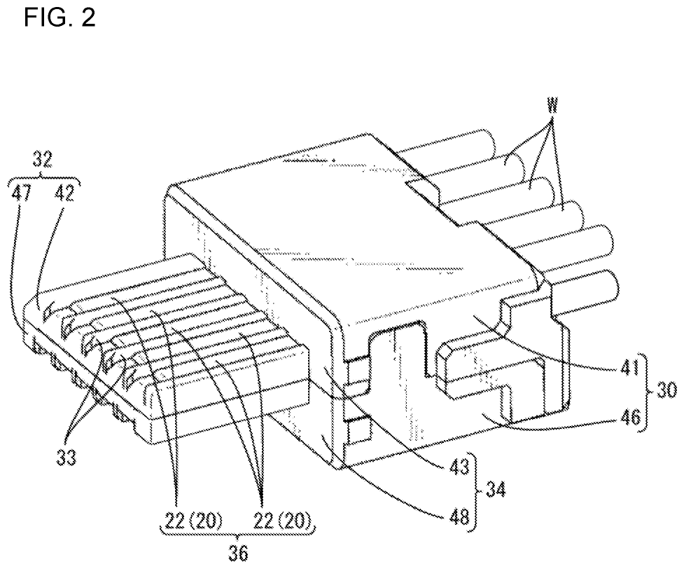

The fitting 32 is fittable to the unillustrated mating connector. As shown in FIGS. 1 to 4, the fitting 32 has a wide flat shape and is connected to a front part of the terminal holding portion 34. Terminal accommodation grooves 33 are formed laterally side by side in upper and lower parts of the fitting 32 in which the terminal connecting portions 22 of the terminals 20 are arranged. In this embodiment, five terminals 20 are arranged side by side in the upper part of the fitting 32. Further, five terminals 20 are arranged side by side in the lower part of the fitting 32 while being shifted in the lateral direction with respect to the terminals 20 in the upper part. As shown in FIG. 2, the terminal accommodation grooves 33 extend in a front-rear direction from a boundary part to the terminal holding portion 34 to a front part of the fitting 32.

That is, as shown in FIGS. 1 to 4, the terminal connecting portions 22 of the terminals 20 are arranged laterally in upper and lower stages in the upper and lower parts of the fitting 32. The terminals 20 in the upper stage are arranged laterally in the upper part of the fitting 32 to define a first terminal group 36, and the terminals 20 in the lower stage are arranged laterally in the lower part of the fitting 32 to define a second terminal group 38. In other words, the first terminal group 36 includes five terminals 20 arranged laterally side by side in the upper part of the fitting 32, and the second terminal group 38 includes five terminals 20 arranged laterally side by side in the lower part of the fitting 32.

[Terminal Holding Portion 34]

As shown in FIGS. 1 to 4, the terminal holding portion 34 has a rectangular parallelepiped shape. As shown in FIG. 3, the terminal connecting portions 22 of the terminals 20 are press-fit into a front part of the terminal holding portion 34 to be held in the housing 30. The wire connecting portions 24 connected to the wires W introduced from behind are accommodated in a rear part of the terminal holding portion 34.

As shown in FIGS. 1 to 4, the housing 30 is configured by assembling a first housing 41 and a second housing 46 in a vertical direction.

[First Housing 41]

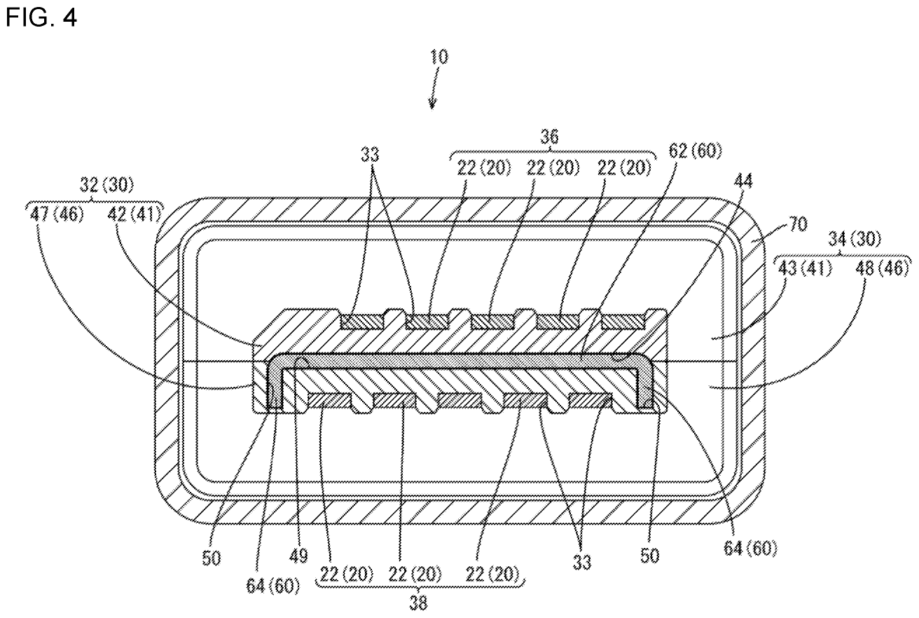

As shown in FIGS. 3 and 4, the first housing 41 is assembled with the second housing 46 from above. The first housing 41 includes a first fitting 42 and a first terminal holding portion 43. The first fitting 42 constitutes the upper part of the fitting 32. The first terminal holding portion 43 is connected behind the first fitting 42, and constitutes an upper part of the terminal holding portion 34. A first mounting recess 44 is formed in a part of the first housing 41 on the side of the second housing 46 and the conductive member 60 is mounted therein.

As shown in FIG. 3, the first mounting recess 44 is formed in a range from a position somewhat behind the front ends of the terminal accommodation grooves 33 in the first fitting 42 to the rear end of the first terminal holding portion 43. Further, as shown in FIG. 4, the first mounting recess 44 is wider than a range where the terminal accommodation grooves 33 are provided in the first fitting 42.

[Second Housing 46]

As shown in FIGS. 3 and 4, the second housing 46 includes a second fitting 47 and a second terminal holding portion 48. The second fitting 47 constitutes the lower part of the fitting 32. The second terminal holding portion 48 is connected behind the second fitting 47, and constitutes a lower part of the terminal holding portion 34.

As shown in FIG. 3, a second mounting recess 49 is formed in a part of the second housing 46 on the side of the first housing 41 and the conductive member 60 is mounted therein. Similarly to the first mounting recess 44 in the first housing 41, the second mounting recess 49 is formed in a range from a position somewhat behind the front ends of the terminal accommodation grooves 33 in the second fitting 47 to the rear end of the second terminal holding portion 48 and is wider than a range where the terminal accommodation grooves 33 are provided in the second fitting 47, as shown in FIG. 4.

Accommodation recesses 50 are formed on both lateral ends of the second mounting recess 49 in the second housing 46. The accommodation recesses 50 are recessed down from the second mounting recess 49 and are recessed more deeply than the terminal accommodation grooves 33 in the second fitting 47.

[Conductive Member 60]

The conductive member 60 is formed by working a conductive metal plate and, as shown in FIG. 4, includes a partition 62 and two extending portions 64.

The partition 62 is a flat plate having a size corresponding to the first and second mounting recesses 44, 49. A thickness of the partition 62 is substantially equal to the sum of the vertical depths of the first and second mounting recesses 44 and 49.

Accordingly, when the first and second housings 41, 46 are assembled, the partition 62 is sandwiched by the first and second mounting recesses 44, 49 from both upper and lower sides, and the conductive member 60 is held in the housing 30, as shown in FIGS. 3 and 4.

Further, when the partition 62 is arranged between the first and second mounting recesses 44, 49, parts of the first terminal group 36 except tip parts of the terminal connecting portions 22 and parts of the second terminal group 38 except tip parts of the terminal connecting portions 22 are partitioned vertically by the partition 62.

As shown in FIG. 4, the two extending portions 64 extend down from both lateral sides of the partition 62. The extending portions 64 are formed over the entire length of the partition 62 in the front-rear direction. Extending dimensions of the extending portions 64 from the partition 62 exceed a distance between the partition 62 and the second terminal group 38. In other words, the pair of extending portions 64 extend to positions for covering side parts of the terminals 20 on both lateral sides in the second terminal group 38.

When the conductive member 60 is held in the housing 30, the extending portions 64 are accommodated into the accommodation recesses 50 of the second housing 46. That is, as shown in FIG. 4, the conductive member 60 is formed such that the partition 62 is covered from both upper and lower sides by the first and second housings 41, 46 and the extending portions 64 are covered from both left and right sides by the second housing 46. Further, the second terminal group 38 is surrounded in three directions (upper, left and right sides) by the partition 62, and the extending portions 64 are covered by the first and second housings 41, 46.

[Shield Shell 70]

The shield shell 70 is formed by working a conductive metal plate. As shown in FIGS. 1, 3 and 4, the shield shell 70 is in the form of a rectangular tube covering the outer periphery of the housing 30. An unillustrated tubular braided wire collectively covering the wires W can be connected to a rear end part of the shield shell 70.

This embodiment is configured as described above. Next, functions and effects of the connector 10 are described.

For example, by arranging a conductive member in the form of a flat plate between a first terminal group and a second terminal group in a housing in which the first and second terminal groups are arranged in upper and lower stages, the terminal groups can be vertically blocked. However, signals and noise of each terminal group easily are transmitted to the other terminal group from both sides of the plate, such as when an interval between the terminal groups is narrow. Thus, there is a concern about electrical adverse effects such as crosstalk occurring between the terminal groups.

Accordingly, the present inventors found out the configuration of this embodiment as a result of an earnest study to solve the above problem. Specifically, this embodiment relates to the connector 10 with the first terminal group 36, the second terminal group 38, the insulating housing 30 and the conductive member 60 having conductivity. The first terminal group 36 includes the terminals 20 arranged side by side, the second terminal group 38 includes the terminals 20 arranged side by side, and the housing 30 holds the first and second terminal groups 36, 38 arranged in two stages. The conductive member 60 includes the partition 62 and the two extending portions 64. The partitioning portion 62 is a plate and is held in the housing 30 to partition between the first and second terminal groups 36, 38. The two extending portions 64 extend toward either the first terminal group 36 or the second terminal group 38 from both lateral sides of the partition 62.

The extending portions 64 suppress the transmission of signals and noise of each terminal group 36, 38 toward the other terminal group from both lateral sides of the partition 62, and the partition 62 partitions between the first and second terminal groups 36, 38. In this way, crosstalk between the first and second terminal groups 36, 38 can be suppressed, and electrical adverse effects on high-frequency characteristics in the first and second terminal groups 36, 38 can be reduced or avoided.

The two extending portions 64 extend to the positions for covering the side parts of either the first or second terminal groups 36, 38.

According to this embodiment, the two extending portions 64 extend to the positions for covering the side parts of the second terminal group 38 so that a large creepage distance between the first and second terminal groups 36, 38 can be secured. In this way, the transmission of signals and noise of each terminal group 36, 38 toward the other terminal group from both lateral sides of the partitioning portion 62 can be reliably suppressed by the extending portions 64.

The extending portions 64 are covered by the housing 30. Thus, the extending portions 64 are not likely to be broken, such as by contacting the mating connector when the connector 10 is connected to the mating connector.

### Other Embodiments

In the above embodiment, the terminal connecting portion 22 is a flat plate. However, there is no limitation to this and a terminal connecting portion may be curved away from the fitting.

In the above embodiment, each of the first and second terminal groups 36, 38 includes five terminals 20. However, there is no limitation to this and each terminal group may include four or less terminals or six or more terminals. Further, the number of the terminals may differ between the first and second terminal groups.

In the above embodiment, the two extending portions 64 extend farther down than the terminals 20 of the second terminal group 38. However, there is no limitation to this and extending portions may not extend farther down than the terminals of the second terminal group if these extend downward. Further, one extending portion may extend obliquely down to be separated from the other extending portion.

In the above embodiment, the extending portions 64 extend down toward the second terminal group 38. However, there is no limitation to this and extending portions may extend up toward the first terminal group.

In the above embodiment, the shield connector to be mounted on the end parts of the wires W is illustrated as an example. However, there is no limitation to this and a connector of the present disclosure may be a shield connector to be mounted on a circuit board or a non-shield connector including no shield shell.

### LIST OF REFERENCE SIGNS

10: connector
20: terminal
22: terminal connecting portion
24: wire connecting portion
30: housing
32: fitting
33: terminal accommodation groove
34: terminal holding portion
36: first terminal group
38: second terminal group
41: first housing
42: first fitting portion
43: first terminal holding portion
44: first mounting recess
46: second housing
47: second fitting portion
48: second terminal holding portion
49: second mounting recess
50: accommodation recess
60: conductive member
62: partition
64: extending portion
70: shield shell
W1: core
W: wire

What is claimed is:

1. A connector (10), comprising a first terminal group (36), a second terminal group (38), an insulating housing (30) and a conductive member (60) having conductivity, wherein:
the first terminal group (36) includes terminals (20) arranged side by side,
the second terminal group (38) includes terminals (20) arranged side by side,
the housing (30) holds the first terminal group (36) and the second terminal group (38) arranged in first and second stages respectively stages,
the conductive member (60) includes a partition (62) and two extending portions (64),
the partition (62) is a plate and is held in the housing (30) to partition between the first terminal group (36) and the second terminal group (38), and
the extending portions (64) extend toward the second terminal group (38) from both sides of the partition (62).

2. The connector of claim 1, wherein the extending portions (64) extend to positions for covering side parts of the second terminal group (38).

3. The connector of claim 2, wherein the extending portions (64) are covered by the housing (30).

4. The connector of claim 1, wherein the extending portions (64) are covered by the housing (30).
